(19) United States
(12) Patent Application Publication
(10) Pub. No.: US 2008/0018092 A1
(43) Pub. Date: Jan. 24, 2008

(54) Jeweled bookmark

(76) Inventors: Nicole A. Zeller, Harrison, NY (US); Gabrielle Zeller, Harrison, NY (US)

Correspondence Address: Donald S. Dowden;Cooper & Dunham LLP, 1185 Avenue of the Americas, New York, NY, 10036, US

(21) Appl. No.: 11/490,904

(22) Filed: Jul. 21, 2006

(51) Int. Cl. B42D 9/00

(52) U.S. Cl. 281/42

(57) ABSTRACT

A bookmark is formed by a length of elastic cord tied near its ends to form a loop and two free end portions. Decorative elements such as beads are arranged along one-half of the loop and along the two free ends. The bookmark may be placed in a book with the loop encircling the spine so that the one half of the loop with decorative elements is placed outside the book such as along the spine, and remaining one-half of the loop without decorative elements being placed between book pages.

### FIELD OF THE INVENTION

This invention relates generally to bookmarks and more particularly to bookmarks that encircle pages or the spine of a book.

### BACKGROUND OF THE INVENTION

Bookmarks currently come in many different forms. One form is the simple ribbon, paper or leather strip, which can slip out of the book when the book is open. Another form is a clip type which clips to one or more pages and which is less likely to slip out of the book, but which can crimp or damage the pages.

Another form of a bookmark is a loop type, like a rubber band that encircles book pages. One example is shown in U.S. Pat. No. 7,004,106 to Forance, which shows an elastic cord bookmark having an elastic loop section and an elastic tail section. The loop section is adapted to encircle the back cover of the book near the spine with the junction of the loop section and tail section at the top of the book.

Another example of a loop type is U.S. Patent Application Publication No. 2005/0172886 A1 to Marcus, which shows a bookmark in the form of an endless loop of elastic band. The loop has decorative elements along a small portion of the band and less than the full length of the spine when the loop encircles the spine. The decorative elements are held in place by knots in the band.

### SUMMARY OF THE INVENTION

It is an object of the present invention to provide a bookmark that cannot become easily dislodged or displaced from the book.

It is another object of the present invention to provide a bookmark that does not cause damage to book pages or the spine.

It is another object of the present invention to provide a bookmark which also provides a distinctive ornamental appearance like a piece of jewelry especially attractive to young girls and women.

The invention provides a bookmark adapted to encircle the inner and outer parts of a book, comprising an elastic cord having a first portion comprising a loop, said loop having a first section with decorative elements along about one-half the distance of the loop and being held in place by stoppers in the loop, and having a second section free of decorative elements, said cord having a second portion formed by free ends of the cord, said second portions having decorative elements extending along their length, whereby the elastic cord may be mounted on a book with the second section mounted inside a book between pages or along an inner spine, the first section mounted outside the book along a cover or along the outer spine, and the second portion located with its cord free ends outside of the book.

The invention provides a bookmark kit comprising a length of elastic cord, a plurality of decorative elements and instructions sufficient to direct a user to make a bookmark according to the description herein.

The invention provides a bookmark adapted to encircle the inner and outer parts of a book, comprising a length of elastic cord forming a loop and two free ends, said loop having a first section with decorative elements along about one-half the distance of the loop and being held in place by stoppers in the loop, and having a second section free of decorative elements, said two free ends of said cord having decorative elements extending along their length, whereby the elastic cord may be mounted on a book with the second section mounted inside a book between pages or along an inner spine, the first section mounted outside the book along a cover or along the outer spine, and with the free cord ends outside of the book.

### DESCRIPTION OF THE DRAWINGS

FIG. 1 is a plan view of an embodiment of a bookmark according to the invention;

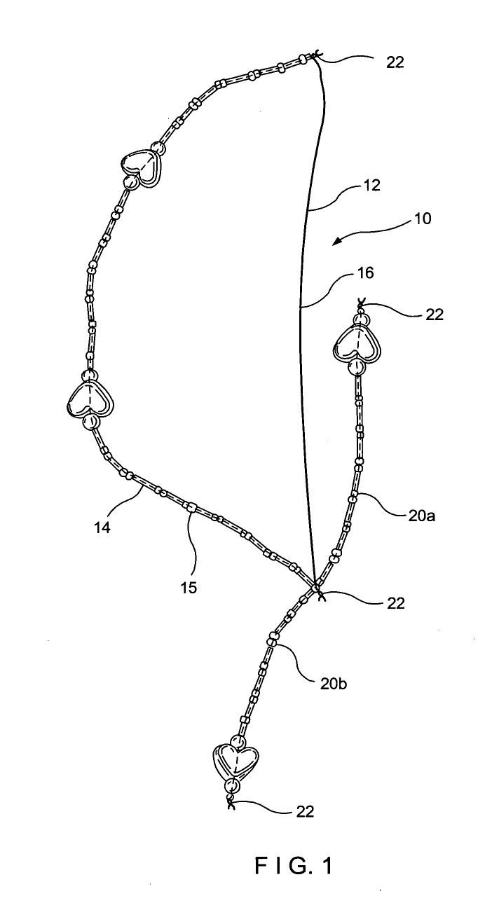

FIG. 2 is a view of the bookmark of FIG. 1 mounted in a book; and

FIG. 3 is a view of a book having two bookmarks being used, one along the spine and one spared from the spine.

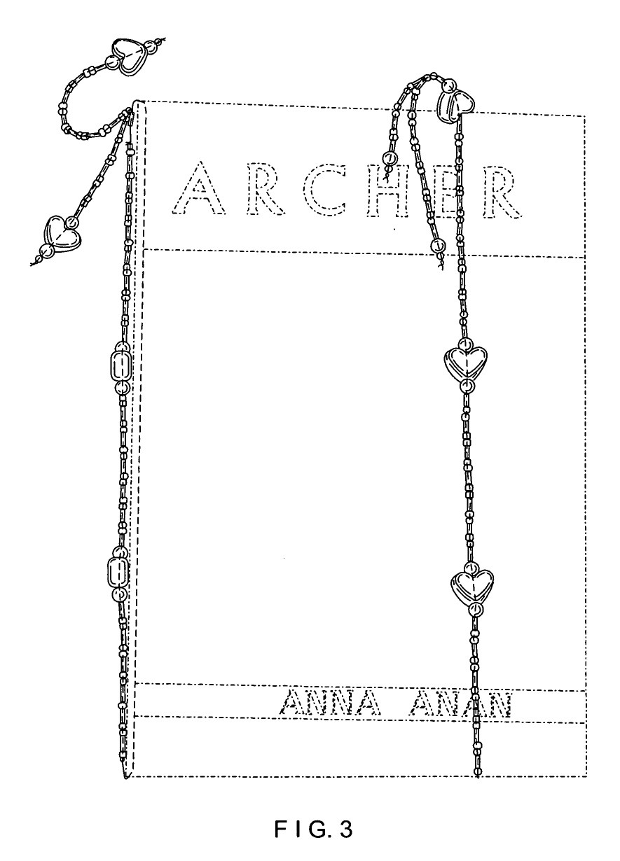

### DESCRIPTION OF THE PREFERRED EMBODIMENT

The invention provides a bookmark adapted to encircle the inner and outer parts of a book, comprising an elastic cord having a first portion comprising a loop, said loop having a first section with decorative elements along about one-half the distance of the loop and being held in place by stoppers in the loop, and having a second section free of decorative elements, said cord having a second portion formed by free ends of the cord, said second portions having decorative elements extending along their length, whereby the elastic cord may be mounted on a book with the second section mounted inside a book between pages or along an inner spine, the first section mounted outside the book along a cover or along the outer spine, and the second portion located with its cord free ends outside of the book.

The stoppers holding the decorative elements in the first section of the cord may be knots in the cord. The cord may be a single length of cord tied near the cord free ends, to form the loop and to form the free ends of the cord. The decorative elements may comprise a plurality of relatively small slender beads and a plurality of relatively larger beads. The relatively larger beads may be heart shaped.

The invention provides a bookmark kit comprising a length of elastic cord, a plurality of decorative elements and instructions sufficient to direct a user to make a bookmark according to the description herein.

The invention provides a bookmark adapted to encircle the inner and outer parts of a book, comprising a length of elastic cord forming a loop and two free ends, said loop having a first section with decorative elements along about one-half the distance of the loop and being held in place by stoppers in the loop, and having a second section free of decorative elements, said two free ends of said cord having decorative elements extending along their length, whereby the elastic cord may be mounted on a book with the second section mounted inside a book between pages or along an inner spine, the first section mounted outside the book along a cover or along the outer spine, and with the free cord ends outside of the book.

An embodiment of a book mark will be described, but the invention is not limited to this embodiment.

An embodiment of a bookmark comprises an elastic cord 10 having several sections or portions. One portion is a loop 12. The loop portion has two sections. A first loop section 14 has decorative elements such as small beads 15 along about one-half of the distance around the loop. The remaining or second section of the loop 16 is free of decorative elements. Another portion of the book mark comprises two tails or free ends 20a and 20b outside of the loop. These ends 20a and 20b have decorative elements along their length. The decorative elements are held in place along the cord by knots 22 in the cord, but other stoppers such as glue may be used to hold the elements in place.

The bookmark may be made by first stringing beads along the length of a cord at the positions described, and then tying knots in the cord to keep the beads at those positions. The cord may then be tied near the ends to create the loop and two free ends or tails.

The bookmark may be placed in a book so that its loop encircles the book pages, wherein its second section (without decorative elements) is inside the book between pages and the first portion (with decorative elements) is outside the book. The second portion of the loop (without decorative elements) may be located deep in the book along the inside of the spine. The cord is slender, having a thickness of about 0.3-0.5 mm, or even less, so that the book can close completely and the cord will not damage or indent the pages.

Because the first section of the loop (with decorative elements) is about one-half of the entire loop length, when the loop is placed around book pages as described above, the decorative elements will be located along the entire, or substantially the entire, length of the cord outside of the book, with its free ends at or near the top or bottom of the book. The first section (with decorative elements) may be located along a front or back cover of the book, or along the outside spine of the book.

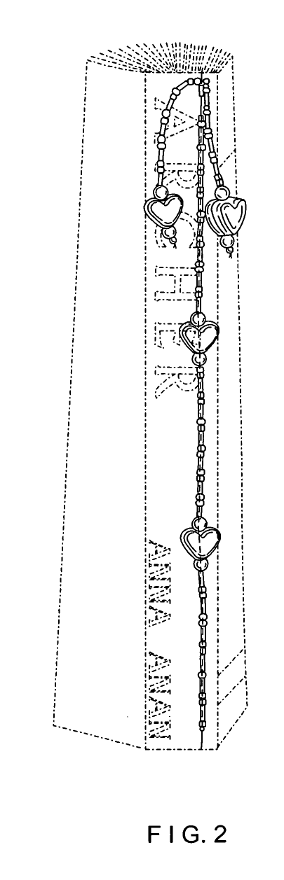

FIG. 2 shows the bookmark in a book with its free ends at the top and the first (decorative element) portion along the outside spine of the book. From the outside of the book, the bookmark may appear to be a length of cord not tied to form a loop, and may also appear to have decorative elements along its entire length, even along the second portion inside the book. However, because the second section is free of decorative elements, the book can be entirely closed to avoid damage or indentation of the book pages.

The decorative elements may be beads having different sizes, such as predominantly smaller beads with one or more larger beads spaced along the decorative portions, as shown. The larger beads may be heart shaped as shown or may have other shapes. The beads may be of the same or different colors, and the cord may be clear or colored.

The bookmark may have its beads sized and shaped for a particular theme or for a particular holiday, such as hearts for Valentine's Day. The beads can also be selected and customized according to taste of the user. For example a young woman interested in tennis can have the beads shaped and colored like tennis balls with larger beads shaped like tennis racquets.

The bookmark may accompany a book given as a gift, with the decorative elements selected according to the theme or subject of the book, such as hearts for a romance novel.

The bookmark may be sold or distributed as a kit with cord and beads, with instructions for mounting the beads on the cord and forming knots in the cord to retain the beads and form the loop to make the bookmark.

The bookmarks may be sold in different sized loops to match different sized books, such as a small size for paperbacks, a medium size for a medium hardcover book, and a large size for larger books, including coffee-table books.

A plurality of bookmarks can be used with the same book. If one bookmark is mounted on the spine, the book pages can turn freely and the other bookmark or bookmarks can be placed away from the spine, or also near the spine at a different place in the book.

While one embodiment has been shown and described, the invention is not limited to this embodiment and its scope is defined by the appended claims.

I claim:

1. A bookmark adapted to encircle the inner and outer parts of a book, comprising:
an elastic cord having a first portion comprising a loop, said loop having a first section with decorative elements along about one-half the distance of the loop and being held in place by stoppers in the loop, and having a second section free of decorative elements, said cord having a second portion formed by free ends of the cord, said second portions having decorative elements extending along their length, whereby the elastic cord may be mounted on a book with the second section mounted inside a book between pages or along an inner spine, the first section mounted outside the book along a cover or along the outer spine, and the second portion located with its cord free ends outside of the book.

2. The bookmark of claim 1 wherein the stoppers holding the decorative elements in the first section of the cord are knots in the cord.

3. The bookmark of claim 1, wherein the cord is a single length of cord tied near the cord free ends, to form the loop and to form the free ends of the cord.

4. The bookmark of claim 1, wherein the decorative elements comprise a plurality of relatively small slender beads and a plurality of relatively larger beads.

5. The bookmark of claim 4, wherein the relatively larger beads are heart shaped.

6. A bookmark kit comprising a length of elastic cord, a plurality of decorative elements and instructions sufficient to direct a user to make a bookmark according to claim 1.

7. A bookmark adapted to encircle the inner and outer parts of a book, comprising:
a length of elastic cord forming a loop and two free ends, said loop having a first section with decorative elements along about one-half the distance of the loop and being held in place by stoppers in the loop, and having a second section free of decorative elements, said two free ends of said cord having decorative elements extending along their length, whereby the elastic cord may be mounted on a book with the second section mounted inside a book between pages or along an inner spine, the first section mounted outside the book along a cover or along the outer spine, and with the free cord ends outside of the book.
